(19) United States
(12) Patent Application Publication
(10) Pub. No.: US 2024/0329908 A1
(43) Pub. Date: Oct. 3, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Yuki SHIMIZU, Kanagawa (JP)

(73) Assignee: FUJIFILM Business Innovation Corp., Tokyo (JP)

(21) Appl. No.: 18/452,577

(22) Filed: Aug. 21, 2023

(30) Foreign Application Priority Data
Mar. 28, 2023 (JP) 2023-052109

(51) Int. Cl. G06F 3/14; G06F 3/03; G06F 3/0481; G06F 3/0484; G06F 3/0488; H04N 23/62

(52) U.S. Cl. CPC G06F 3/1423; G06F 3/0304; G06F 3/0481; G06F 3/0484; G06F 3/0488; H04N 23/62; H04N 5/2628

(57) ABSTRACT

An information processing system includes at least one processor configured to: cause a terminal of a user to display, if a captured image of an image processing apparatus captured by the terminal includes an operation screen of the image processing apparatus, the operation screen included in the captured image as a terminal-side operation screen; and cause each of the terminal and the image processing apparatus to perform processing according to an operation on an element included on the terminal-side operation screen.

### CROSS-REFERENCE TO RELATED APPLICATIONS

This application is based on and claims priority under 35 USC 119 from Japanese Patent Application No. 2023-052109 filed Mar. 28, 2023.

### BACKGROUND

### (i) Technical Field

The present disclosure relates to an information processing system, an information processing method, and a non-transitory computer readable medium.

### (ii) Related Art

An image processing apparatus, also referred to as a multi-function device, which is installed in an office or other space and which enables the printing and reading of documents, has an operation screen that may be operated by multiple users present in the space. For this reason, users may desire to operate an image processing apparatus without touching the operation screen thereof for reasons of hygiene and the like. In this regard, there is a known technology that allows the operation screen of an image processing apparatus to be operated from a mobile terminal while also reducing the amount of data transmitted and received by storing image data of the operation screen of the image processing apparatus on the mobile terminal side in advance (for example, see Japanese Unexamined Patent Application Publication No. 2021-170370).

### SUMMARY

However, since the operation screen of an image processing apparatus may be different depending on the equipment model or version and may also be customized by the user, the content of the operation screen of the image processing apparatus stored in advance on the mobile terminal side may differ from the content of the actual operation screen on the image processing apparatus side, and an intended operation may be unavailable from the mobile terminal side.

Aspects of non-limiting embodiments of the present disclosure relate to allowing an image processing apparatus to be operated from a mobile terminal without storing image data of the operation screen of the image processing apparatus on the mobile terminal side in advance.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including at least one processor configured to: cause a terminal of a user to display, if a captured image of an image processing apparatus captured by the terminal includes an operation screen of the image processing apparatus, the operation screen included in the captured image as a terminal-side operation screen; and cause each of the terminal and the image processing apparatus to perform processing according to an operation on an element included on the terminal-side operation screen.

### BRIEF DESCRIPTION OF THE DRAWINGS

An exemplary embodiment of the present disclosure will be described in detail based on the following figures, wherein:

FIG. 1 is a diagram illustrating an example of the overall configuration of an information processing system to which an exemplary embodiment is applied;

FIG. 2 is a diagram illustrating an example of a hardware configuration of a user terminal;

FIG. 3 is a diagram illustrating an example of a hardware configuration of an image processing apparatus;

FIG. 4 is a diagram illustrating an example of a functional configuration of a control unit of a user terminal;

FIG. 5 is a diagram illustrating an example of a functional configuration of a control unit of an image processing apparatus;

FIG. 6 is a flowchart illustrating an example of a flow of processes in a user terminal up to displaying a terminal-side operation screen;

FIG. 7 is a flowchart illustrating an example of a flow of processes in a user terminal from accepting an input operation on a terminal-side operation screen to changing the terminal-side operation screen;

FIG. 8 is a diagram illustrating a situation in which an image of the operation screen of an image processing apparatus is captured with a user terminal;

FIG. 9 is a diagram illustrating a situation in which an operation is performed on a terminal-side operation screen;

FIG. 10 is a diagram illustrating a situation in which a software keyboard is displayed on a terminal-side operation screen;

FIG. 11 is a diagram illustrating automatic image capture; and

FIG. 12 is a diagram illustrating a specific example of automatic reading of a terminal-side operation screen stored in a user terminal.

### DETAILED DESCRIPTION

An exemplary embodiment of the present disclosure will be described below with reference to the accompanying drawings.

### (User Terminal)

The user terminal 10 is a mobile information processing device such as a smartphone or a tablet that is operated by a user who uses the information processing system 1. Application software enabling operation of the image processing apparatus 50 is installed in the user terminal 10. The user terminal 10 acquires and performs various kinds of processing on various information transmitted from the image processing apparatus 50. The user terminal 10 also transmits various information to the image processing apparatus 50.

For example, the user terminal 10 determines whether a captured image of the image processing apparatus 50 includes an operation screen of the image processing apparatus 50. The user terminal 10 also determines the types of elements on the operation screen. If it is determined that a captured image of the image processing apparatus 50 includes the operation screen of the image processing apparatus 50, the user terminal 10 displays the operation screen included in the captured image as a user interface. Specifically, the user terminal 10 extracts the display area of the operation screen included in the captured image and performs enlargement, tilt correction, and the like to generate a terminal-side operation screen as a user interface enabling operation of the image processing apparatus 50, and displays the terminal-side operation screen on a display unit.

Also, the user terminal 10 performs processing according to an operation on an element included on the terminal-side operation screen. For example, the user terminal 10 activates a camera for capturing an image of the operation screen of the image processing apparatus 50 as processing according to an operation on an element included on the terminal-side operation screen. In this case, if the operation on an element included on the terminal-side operation screen is an operation of pressing a button for changing screens, the user terminal 10 activates a camera for capturing an image of the operation screen of the image processing apparatus 50 after the screen change as processing according to the operation. In the case of activating a camera for capturing an image of the operation screen of the image processing apparatus 50 after a screen change, the user terminal 10 may capture an image of the operation screen automatically when the operation screen of the image processing apparatus 50 is displayed as the object of image capture in a viewfinder.

Also, the user terminal 10 activates a software keyboard for accepting text input as the processing according to an operation on an element included on the terminal-side operation screen. For example, if the operation on an element included on the terminal-side operation screen is an operation of selecting an object to input text into, the user terminal 10 activates a software keyboard for accepting text input as the processing according to the operation.

The “object to input text into” is a text box, for example. In the case of activating a software keyboard for accepting text input, the user terminal 10 accepts an operation of copying text data stored in the user terminal 10 itself and an operation of pasting the copied text data. Moreover, the “text data stored in the user terminal 10 itself” is data from an address book stored in the user terminal 10, for example.

The user terminal 10 manages a terminal-side operation screen displayed as a result of an operation performed on an element included on the terminal-side operation screen in association with information pertaining to the operation. Thereafter, if the operation is performed on an element included on the terminal-side operation screen, the user terminal 10 displays the terminal-side operation screen associated with the information pertaining to the operation. In addition, the user terminal 10 displays the terminal-side operation screen together with a button for activating a camera for capturing an image of the operation screen of the image processing apparatus 50. Note that details of the processing by the user terminal 10 will be described later.

### (Image Processing Apparatus)

The image processing apparatus 50 is an information processing apparatus that performs various kinds of processing in response to input operations by a user who uses the information processing system 1. For example, the image processing apparatus 50 performs processing for forming an image on a medium such as paper, processing for outputting a recording medium on which an image is formed, processing for reading an image formed on paper or the like. Examples of the image processing apparatus 50 include what is called an electrophotographic multi-function device that forms a toner image onto a paper printing surface, what is called inkjet printer that ejects ink onto a paper printing surface, and the like.

The image processing apparatus 50 also acquires and performs various kinds of processing on various information transmitted from the user terminal 10. The image processing apparatus 50 also transmits various information to the user terminal 10. For example, the image processing apparatus 50 performs processing according to an operation on an element included on the terminal-side operation screen. Specifically, the image processing apparatus 50 performs, as the processing according to an operation on an element included on the terminal-side operation screen, processing for accepting the operation as an operation on the operation screen of the image processing apparatus 50 itself. Note that details of the processing by the image processing apparatus 50 will be described later.

The configuration of the information processing system 1 described above is an example, and functions for achieving the above processing may simply be provided in the information processing system 1 as a whole. Consequently, some or all of the functions for achieving the above processing may be allocated or achieved cooperatively within the information processing system 1. That is, some or all of the functions of the user terminal 10 may also be functions of the image processing apparatus 50, and some or all of the functions of the image processing apparatus 50 may also be functions of the user terminal 10. Moreover, some or all of the functions of each of the user terminal 10 and the image processing apparatus 50 included in the information processing system 1 may also be delegated to another server or the like not illustrated. This arrangement makes it possible to facilitate processing by the information processing system 1 as a whole and also cause processes to complement one another.

### (Hardware Configuration of User Terminal)

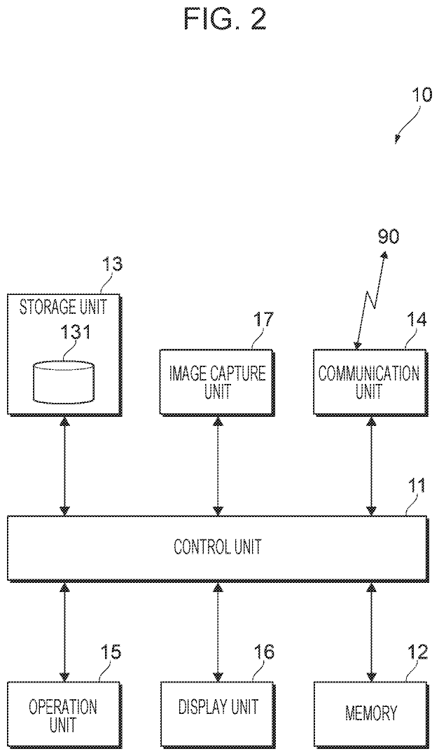

FIG. 2 is a diagram illustrating an example of a hardware configuration of the user terminal 10. The user terminal 10 includes a control unit 11, a memory 12, a storage unit 13, a communication unit 14, an operation unit 15, a display unit 16, and an image capture unit 17. These units are connected by a data bus, an address bus, a Peripheral Component Interconnect (PCI) bus, and the like.

The control unit 11 is a processor that controls the functions of the user terminal 10 through the execution of various software such as an operating system (OS; basic software) and application software. The control unit 11 includes a central processing unit (CPU), for example. The memory 12 is a storage area storing various software, data used in the execution of the software, and the like, and is also used as a work area when performing computations. The memory 12 includes random access memory (RAM), for example.

The storage unit 13 is a storage area that stores information such as input data for various software and output data from various software. The storage unit 13 includes a device such as a hard disk drive (HDD), a solid-state drive (SSD), or a semiconductor memory used to store programs and various settings data, for example. The storage unit 13 contains databases storing various information, such as an image DB 131 storing information associating a captured image, an operation screen included in the captured image, and the content of an operation, for example.

The communication unit 14 transmits and receives data with the user terminal 10 over the network 90. The operation unit 15 includes a keyboard, a mouse, and mechanical buttons and switches, for example, and accepts input operations. The operation unit 15 also includes a touch sensor that is integrated with the display unit 16 to form a touch panel. The display unit 16 includes a liquid crystal display (LCD) or an organic light-emitting diode (OLED) display used to display information, for example, and displays image, text data, and the like. The image capture unit 17 includes a camera or the like, captures an image of a subject displayed on the display unit 16, which also functions as a viewfinder of the camera, and acquires the captured subject as the data of an image.

### (Hardware Configuration of Image Processing Apparatus)

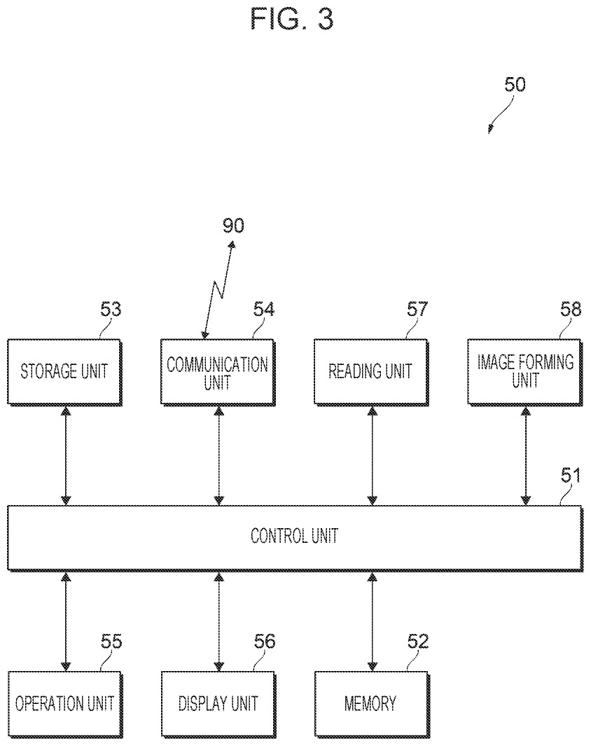

FIG. 3 is a diagram illustrating an example of a hardware configuration of the image processing apparatus 50. The image processing apparatus 50 has a hardware configuration corresponding to each of the control unit 11, memory 12, storage unit 13, communication unit 14, operation unit 15, and display unit 16 in the hardware configuration of the user terminal 10 in FIG. 2.

That is, the image processing apparatus 50 includes a control unit 51 formed from a processor such as a CPU, a memory 52 formed as a storage area in RAM or the like, and a storage unit 53 formed as a storage area in an HDD, SSD, semiconductor memory, or the like. A database storing various information is stored in the storage unit 53. The image processing apparatus 50 also includes a communication unit 54 that transmits and receives data with the user terminal 10 and external equipment over the network 90. The image processing apparatus 50 also includes an operation unit 55 including a touch panel or the like and a display unit 56 including an LCD display, OLED display, or the like.

Furthermore, in addition to the above components, the image processing apparatus 50 includes a reading unit 57 and an image forming unit 58. The reading unit 57 reads an image recorded on a medium such as paper (such as a document on a paper medium, for example) as the recording medium. The reading unit 57 includes, for example, a charge-coupled device (CCD) scanner in which light from a light source is radiated onto a document and the reflected light therefrom is focused by a lens and sensed by a CCD or a contact image sensor (CIS) scanner in which light from LED light sources is consecutively radiated onto a document and the reflected light therefrom is sensed by a CIS. In one example, the image forming unit 58 forms an image to be printed onto the printing surface of paper as a recording medium according to an electrophotographic system, an inkjet method, or the like. In addition, these units are connected by a data bus, an address bus, a PCI bus, and the like.

### (Functional Configuration of Control Unit of User Terminal)

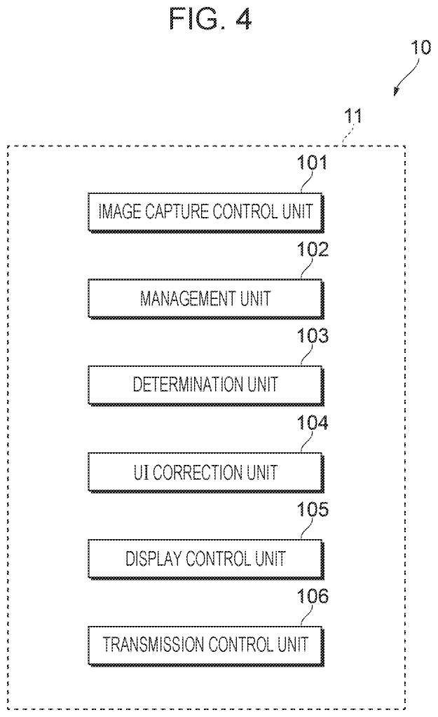

FIG. 4 is a diagram illustrating an example of a functional configuration of the control unit 11 in the user terminal 10. In the control unit 11 of the user terminal 10, an image capture control unit 101, a management unit 102, a determination unit 103, a UI correction unit 104, a display control unit 105, and a transmission control unit 106 function.

The image capture control unit 101 causes the image capture unit 17 to capture an image of the operation screen of the image processing apparatus 50. Specifically, the image capture control unit 101 activates the camera of the image capture unit 17 on the basis of a user operation and causes the camera to capture an image of the operation screen of the image processing apparatus 50. Here, the “user operation” is an operation of pressing a shutter button of the camera, an operation causing the operation screen of the image processing apparatus 50 to be displayed in the viewfinder of the camera, or the like.

The management unit 102 stores and manages various information in a database of the storage unit 13 (see FIG. 2). For example, the management unit 102 stores and manages captured images captured by the image capture unit 17 (see FIG. 2) in an image DB 131. Specifically, the management unit 102 stores and manages information associating a captured image captured by the image capture unit 17, an operation screen included in the captured image, and the content of an operation in the image DB 131 as training data.

The determination unit 103 determines whether a captured image of the image processing apparatus 50 captured by the image capture unit 17 includes the operation screen of the image processing apparatus 50. Specifically, the determination unit 103 determines whether each of one or more objects included in the captured image of the image processing apparatus 50 corresponds to an element of the operation screen of the image processing apparatus 50. At this time, the determination unit 103 determines the types of elements on the operation screen. Types of elements include buttons, text boxes, and the like serving as a user interface, for example.

In determining whether the operation screen is included in the captured image of the image processing apparatus 50, the determination unit 103 may make a determination based on a result of machine learning. In this case, the training data may include, in addition to information associating information about an operation performed on an element included on the operation screen with a captured image of the operation screen displayed on the image processing apparatus 50 as a result of the operation, information pertaining to designs and rules governing the operation screen of the image processing apparatus 50, for example.

The UI correction unit 104 corrects the captured image of the operation screen of the image processing apparatus 50 to generate a terminal-side operation screen as a user interface enabling operation of the image processing apparatus 50. Specifically, the UI correction unit 104 extracts the area of the operation screen included in the captured image of the image processing apparatus 50 and performs enlargement, tilt correction, and the like to generate the terminal-side operation screen. That is, the terminal-side operation screen to be displayed on the user terminal 10 is not determined independently and separately from the operation screen of the image processing apparatus 50, but rather is obtained by correcting the appearance of a captured image of the operation screen of the image processing apparatus 50.

The display control unit 105 controls the displaying of various information on the display unit 16 of the user terminal 10. Specifically, the display control unit 105 controls the display, on the display unit 16, of the viewfinder of the activated camera. The display control unit 105 also controls the display, on the display unit 16, of the image processing apparatus 50 treated as the subject. The display control unit 105 also controls the display, on the display unit 16, of the terminal-side operation screen generated by the UI correction unit 104. The display control unit 105 also controls the display, on the display unit 16, of a software keyboard for accepting text input.

The transmission control unit 106 controls the transmission of various information. Specifically, the transmission control unit 106 controls the transmission of various information to each of the image processing apparatus 50 and external equipment. Among the information of which the transmission is controlled by the transmission control unit 106, the information transmitted to the image processing apparatus 50 is, for example, input information inputted into the terminal-side operation screen to cause the image processing apparatus 50 to execute various kinds of processing.

### (Functional Configuration of Control Unit of Image Processing Apparatus)

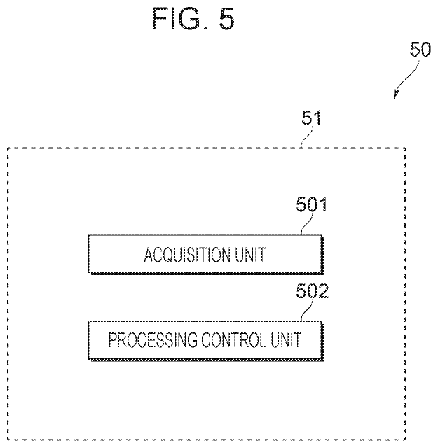

FIG. 5 is a diagram illustrating an example of the functional configuration of the control unit 51 of the image processing apparatus 50. In the control unit 51 of the image processing apparatus 50, an acquisition unit 501 and a processing control unit 502 function.

The acquisition unit 501 acquires various information. Specifically, the acquisition unit 501 acquires various information transmitted from the user terminal 10 and external equipment. Among the information acquired by the acquisition unit 501, the information transmitted from the user terminal 10 is, for example, input information inputted into the terminal-side operation screen to cause the image processing apparatus 50 to execute various kinds of processing.

The processing control unit 502 controls the execution of various kinds of processing involving functions of the image processing apparatus 50, such as the communication unit 54, the display unit 56, the reading unit 57, and the image forming unit 58 (see FIG. 3), on the basis of input information which is inputted into the terminal-side operation screen to cause the image processing apparatus 50 to execute various kinds of processing and which is transmitted from the user terminal 10. For example, the processing control unit 502 changes the display of the operation screen on the basis of input information inputted into the terminal-side operation screen to cause the image processing apparatus 50 to execute various kinds of processing.

### <Flow of Processes>

### (Flow of Processes in User Terminal)

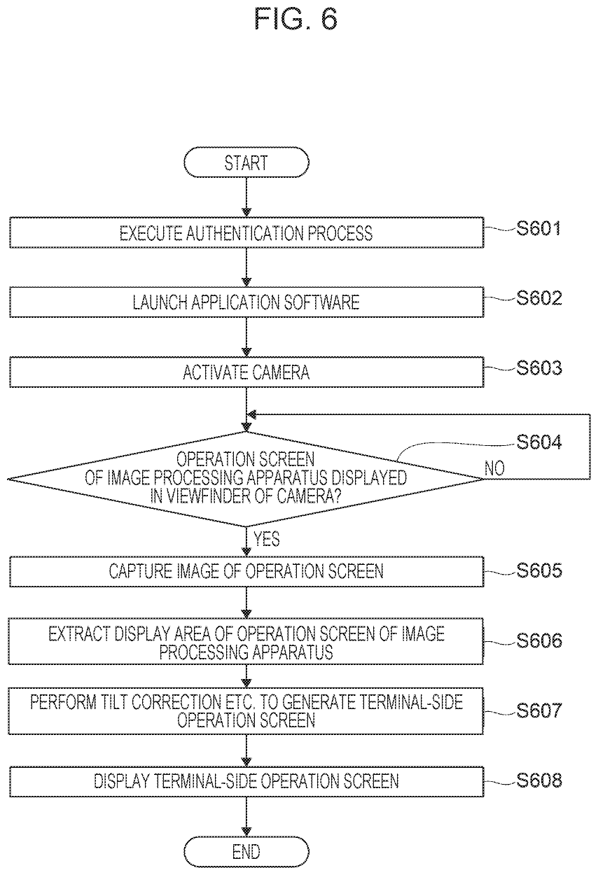

FIG. 6 is a flowchart illustrating an example of the flow of processes in the user terminal 10 up to displaying the terminal-side operation screen. The user terminal 10 executes, on the basis of a user operation, an authentication process for connecting to the image processing apparatus 50 to be operated (step 601) and launches application software enabling operation of the image processing apparatus 50 (step 602).

Next, the user terminal 10 activates the camera on the basis of a user operation (step 603). Thereafter, if the operation screen of the image processing apparatus 50 is displayed in the viewfinder of the camera (step 604, YES), the user terminal 10 captures an image of the operation screen (step 605). In contrast, if the operation screen of the image processing apparatus 50 is not displayed in the viewfinder of the camera (step 604, NO), the user terminal 10 repeats the determination process in step 604 until the operation screen of the image processing apparatus 50 is displayed in the viewfinder of the camera.

Next, the user terminal 10 extracts the display area of the operation screen of the image processing apparatus 50 included in the captured image that was captured in step 605 (step 606), and performs tilt correction and the like to generate the terminal-side operation screen (step 607). The user terminal 10 then displays the generated terminal-side operation screen (step 608).

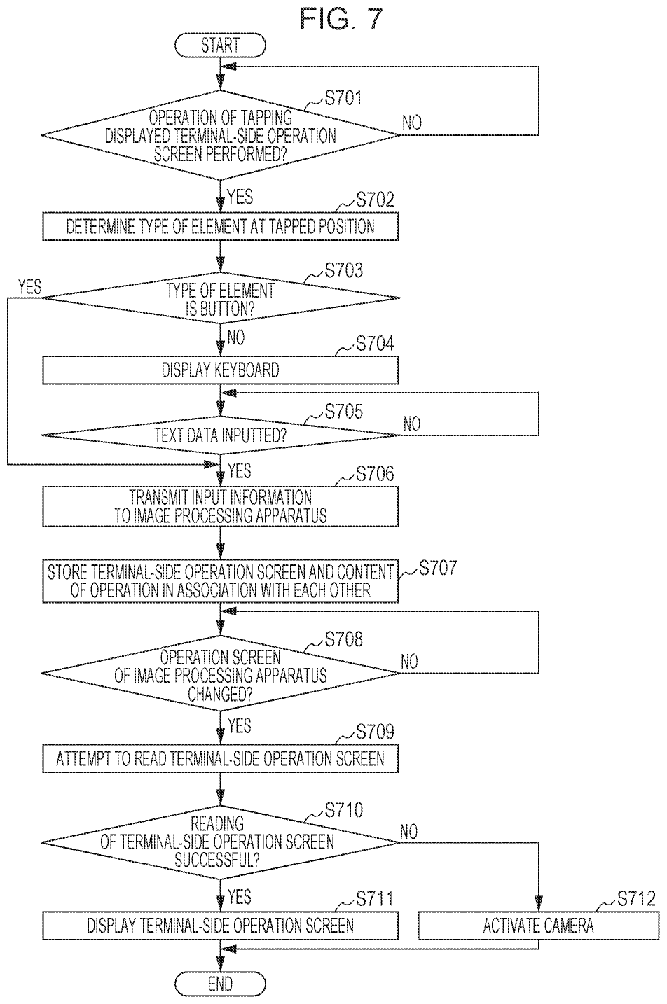

FIG. 7 is a flowchart illustrating an example of the flow of processes in the user terminal 10 from accepting an input operation on the terminal-side operation screen to changing the terminal-side operation screen. If an operation of tapping the displayed terminal-side operation screen is performed (step 701, YES), the user terminal 10 determines the type of element at the tapped position (step 702). In contrast, if a tap operation is not performed, the user terminal 10 repeats the determination process in step 701 until a tap operation is performed.

If the type of element at the tapped position is a button (step 703, YES), the user terminal 10 proceeds to the process in step 706. In contrast, if the type of element at the tapped position is a text box (step 703, NO), the user terminal 10 displays a keyboard (step 704) and prompts for the input of text data. Thereafter, if text data is inputted (step 705, YES), the user terminal 10 proceeds to the process in step 706. In contrast, if text data is not inputted (step 705, NO), the user terminal 10 repeats the determination process in step 705 until text data is inputted.

The user terminal 10 transmits, to the image processing apparatus 50, input information for causing the image processing apparatus 50 to execute various kinds of processing (step 706), and stores the terminal-side operation screen and the content of an operation in association with each other (step 707).

If the operation screen of the image processing apparatus 50 changes due to the input information transmitted to the image processing apparatus 50 in step 706 (step 708, YES), the user terminal 10 attempts to read the terminal-side operation screen corresponding to the changed operation screen (step 709). In contrast, if the operation screen of the image processing apparatus 50 does not change (step 708, NO), the determination process in step 708 is repeated until the operation screen of the image processing apparatus 50 changes.

If the reading of the terminal-side operation screen is successful (step 710, YES), the user terminal 10 displays the read terminal-side operation screen (step 711). In contrast, if the reading of the terminal-side operation screen is not successful (step 710, NO), the camera is activated to capture an image of the change operation screen being displayed on the image processing apparatus 50 (step 712). In this case, the user terminal 10 performs the processes from the determination process in step 604 of FIG. 6 described above, for example.

### Specific Example

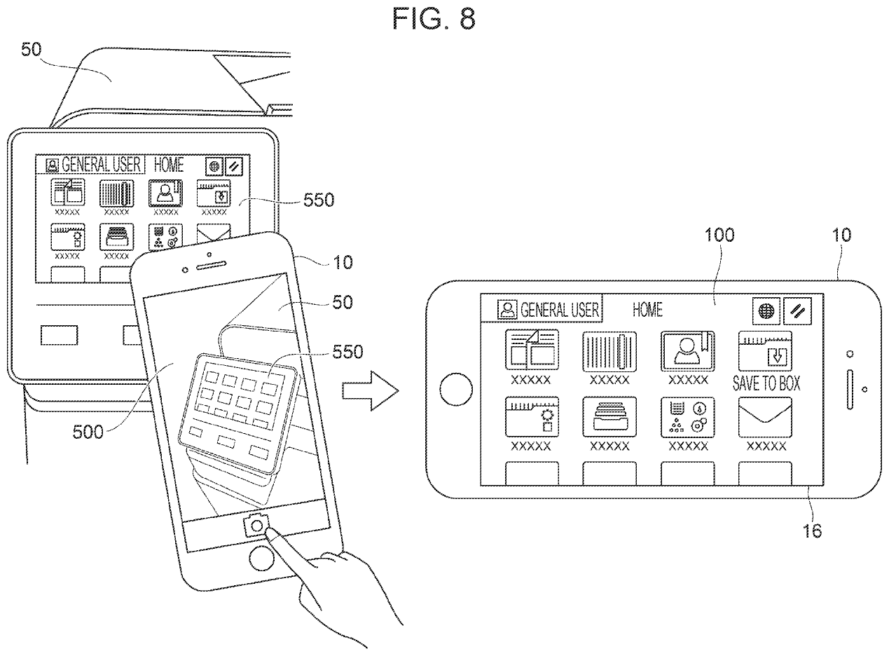

FIG. 8 is a diagram illustrating a situation in which an image of the operation screen of the image processing apparatus 50 is captured with the user terminal 10. A user, who is attempting to operate the image processing apparatus 50 from a mobile terminal or the like without directly touching the operation screen of the image processing apparatus 50, operates the user terminal 10 in which the application software enabling operation of the image processing apparatus 50 is installed, and thereby carries out authentication for connecting to the image processing apparatus 50 to be operated.

Next, the user activates the camera of the user terminal 10, causes an operation screen 550 of the operation unit 55 (see FIG. 3) of the image processing apparatus 50 to be displayed in the viewfinder of the user terminal 10, and captures an image. Thereafter, the display area of the operation screen 550 included in the captured image 500 is extracted and subjected to various types of correction, and a terminal-side operation screen 100 is generated as a user interface enabling operation of the image processing apparatus 50. The generated terminal-side operation screen 100 is displayed on the display unit 16 of the user terminal 10. The form of the terminal-side operation screen 100 displayed on the display unit 16 of the user terminal 10 is not particularly limited. For example, as illustrated in FIG. 8, the operation screen is displayed in a form that is easily operated by the user, such as by being adjusted and enlarged or the like to fit the size of the display unit 16 of the user terminal 10.

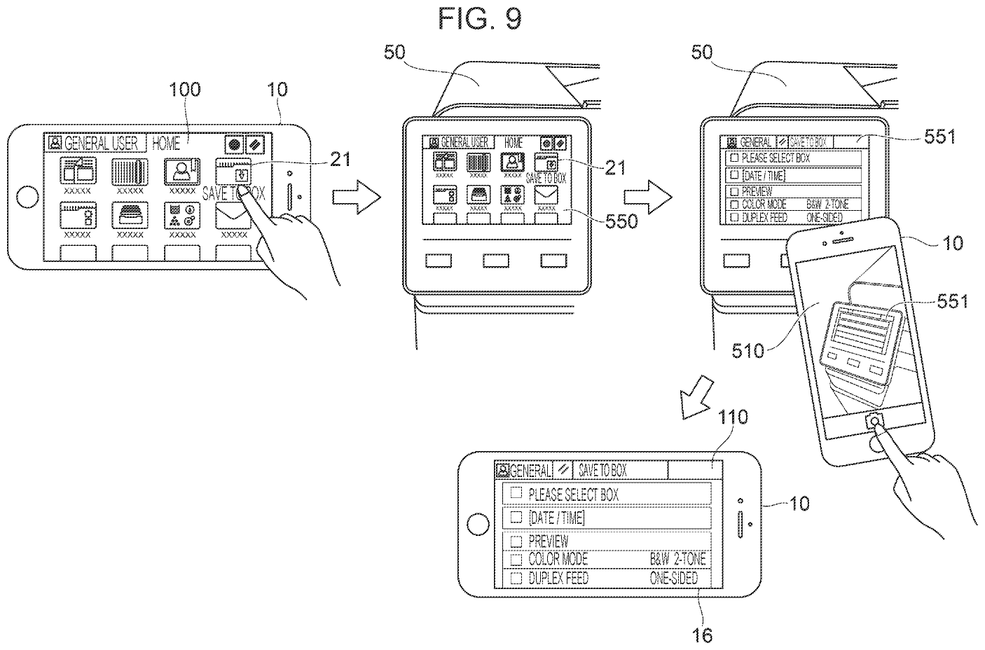

FIG. 9 is a diagram illustrating a situation in which an operation is performed on the terminal-side operation screen 100. If the user performs a tap operation or a text input operation on an element (such as a button or a text box) displayed on the terminal-side operation screen 100, the input information is transmitted to the image processing apparatus 50. The image processing apparatus 50, having obtained the input information with respect to the terminal-side operation screen 100, accepts the input information as an input operation with respect to the operation screen 550 and performs processing (such as a screen change, printing, or reading) according to the input operation.

For example, as illustrated in FIG. 9, if a button 21 labeled “Save to Box” is pressed from among the elements included on the terminal-side operation screen 100, the operation is accepted as the pressing of the button 21 labeled “Save to Box” from among the elements included on the operation screen 550 of the image processing apparatus 50. This causes the operation screen 550 of the image processing apparatus 50 to change to an operation screen 551.

At this point, if a terminal-side operation screen corresponding to the operation screen 551 is stored in the user terminal 10, the terminal-side operation screen is displayed on the user terminal 10. In contrast, if a terminal-side operation screen corresponding to the operation screen 551 is not stored in the user terminal 10, the camera of the user terminal 10 is activated again. The user causes the operation screen 551 of the image processing apparatus 50 to be displayed in the viewfinder of the user terminal 10 and captures an image. Thereafter, the display area of the operation screen 551 included in the captured image 510 is extracted and subjected to various types of correction, and a terminal-side operation screen 110 corresponding to the operation screen 551 is generated. The generated terminal-side operation screen 110 is displayed on the display unit 16.

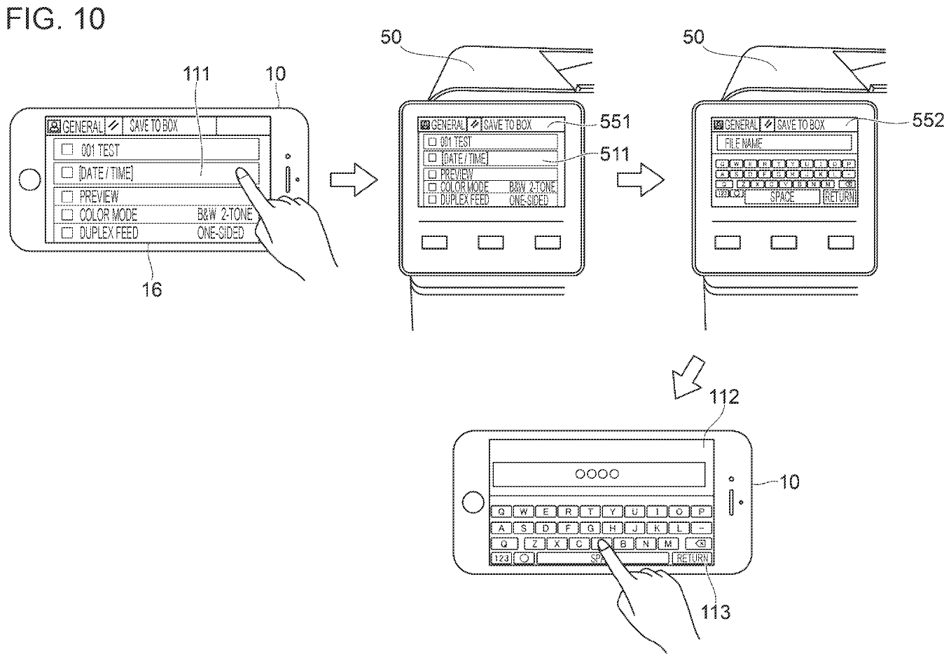

FIG. 10 is a diagram illustrating a situation in which a software keyboard is displayed on a terminal-side operation screen. If an operation on an element included on the terminal-side operation screen is an operation of selecting a text box, a software keyboard for accepting text input is displayed on the display unit 16 of the user terminal 10. For example, as illustrated in FIG. 10, if an operation of tapping a text box 111 labeled “Date” is performed, the input information is transmitted to the image processing apparatus 50. In the image processing apparatus 50 having obtained the input information, the operation is accepted as an operation of tapping the text box 511 labeled “Date” included on the operation screen 551. This causes the operation screen 551 of the image processing apparatus 50 to change to an operation screen 552.

Also, if an operation of tapping the text box 111 is performed, the user terminal 10 detects that the tapped element is a text box and displays a software keyboard 112 for accepting the input of text data. If the user inputs text into the software keyboard 112 and performs an operation of tapping a button 113 labeled “Return” (or an “Enter” key not illustrated), the text data inputted into the software keyboard 112 is transmitted to the image processing apparatus 50 as input information. Thereafter, the user terminal 10 detects that the input operation into the software keyboard 112 is complete and activates the camera again to enable the capture of an image of the operation screen of the image processing apparatus 50.

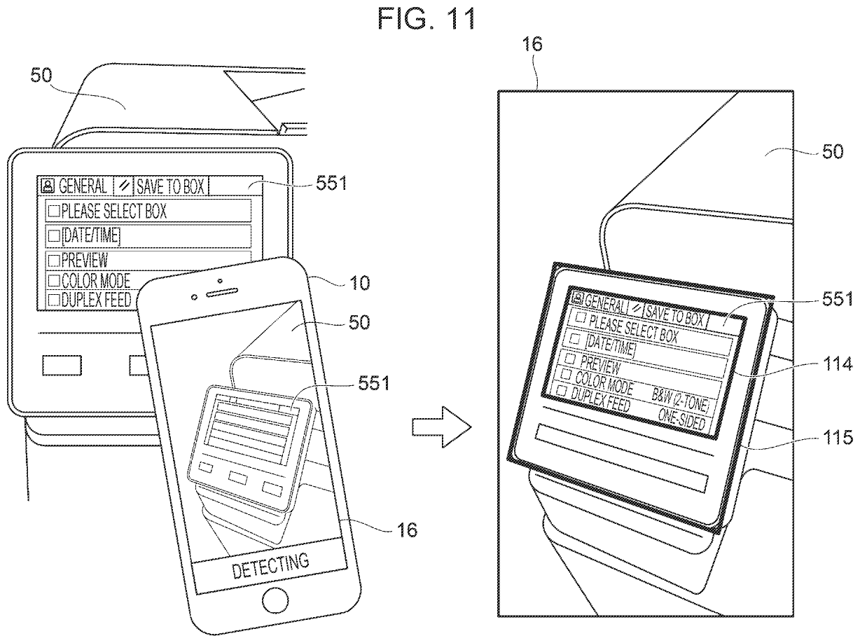

FIG. 11 is a diagram illustrating automatic image capture. In the case of activating the camera for capturing an image of the operation screen 551 of the image processing apparatus 50 after a screen change, an image of the operation screen 551 is captured automatically when the operation screen 551 of the image processing apparatus 50 is displayed as the object of image capture in the viewfinder of the user terminal 10. That is, the operation screen 551 of the image processing apparatus 50 continues to be detected while the camera of the user terminal 10 is active. The frame lines 114 and 115 in FIG. 11 indicate confirmation of the display area of the operation screen 551 of the image processing apparatus 50 displayed in the viewfinder of the display unit 16 of the user terminal 10.

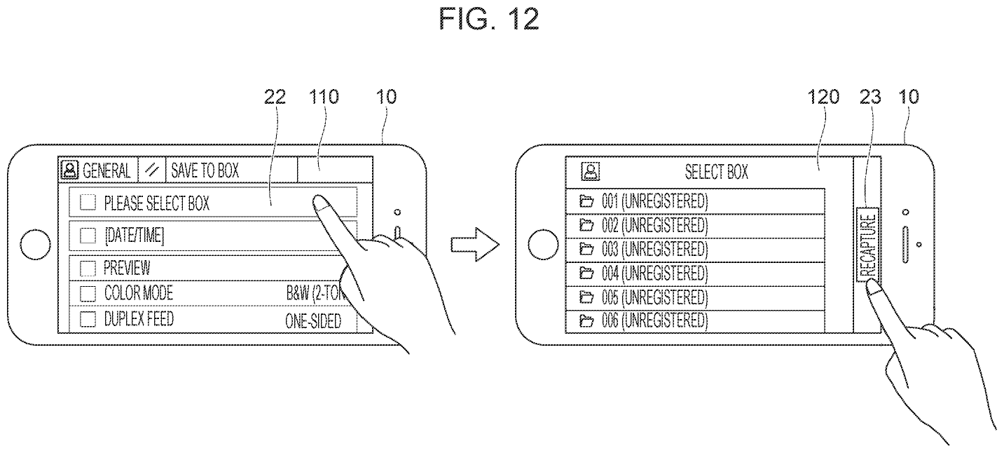

FIG. 12 is a diagram illustrating a specific example of automatic reading of a terminal-side operation screen stored in the user terminal 10. As described above, information associating a captured image captured by the image capture unit 17, an operation screen included in the captured image, and the content of an operation is stored in the image DB 131 (see FIG. 2) which is stored in the user terminal 10. If an operation similar to the stored content of an operation is performed, the user terminal 10 automatically reads the terminal-side operation screen associated with the content of an operation.

FIG. 12 illustrates a terminal-side operation screen 120 that is read automatically in response to the performing of an operation of tapping a button 22 as an element included on the terminal-side operation screen 110. The reading of the terminal-side operation screen is achieved by a process of inputting the currently displayed terminal-side operation screen (for example, the terminal-side operation screen 110 in FIG. 12), the type of operation (such as an operation of tapping, for example) performed on the currently displayed terminal-side operation screen, and coordinates indicating the position on the screen where the operation was performed, and outputting the next terminal-side operation screen (for example, the terminal-side operation screen 120 in FIG. 12).

However, since the layout of the operation screen may vary depending on changes to settings and the like on the image processing apparatus 50 side, a button 23 labeled “Recapture” is provided. If the terminal-side operation screen 120 stored in the user terminal 10 does not match the actual operation screen of the image processing apparatus 50, the user performs an operation of tapping the button 23. This activates the camera to enable image capture of the actual operation screen of the image processing apparatus 50.

### Other Exemplary Embodiments

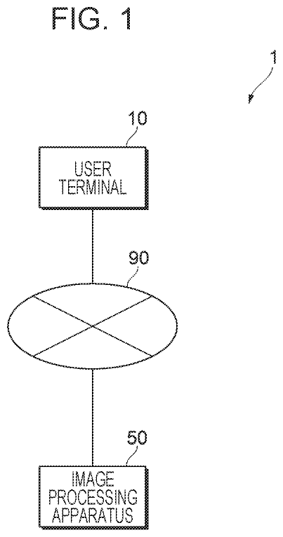

The foregoing describes an exemplary embodiment of the present disclosure, but the present disclosure is not limited to the exemplary embodiment described above. Moreover, the effects produced by an exemplary embodiment of the present disclosure are not limited to those indicated in relation to the exemplary embodiment described above. For example, the configuration of the information processing system 1 illustrated in FIG. 1, the hardware configuration of the user terminal 10 illustrated in FIG. 2, and the hardware configuration of the image processing apparatus 50 illustrated in FIG. 3 are all merely illustrative examples for achieving an objective of the present disclosure and are not particularly limiting. Likewise, the functional configuration of the user terminal 10 illustrated in FIG. 4 and the functional configuration of the image processing apparatus 50 illustrated in FIG. 5 are merely illustrative examples and are not particularly limiting. Insofar as functionality for executing the processes described above as a whole is provided in the information processing system 1 of FIG. 1, the functional configuration to be used for achieving the functionality is not limited to the examples in FIGS. 4 and 5.

The sequence of the steps of the processes by the user terminal 10 illustrated in FIGS. 6 and 7 is merely an illustrative example and is not particularly limiting. The processes may not only be performed in a time series following the sequence of steps illustrated in the flowcharts, but may also be performed in parallel or individually, without necessarily being performed in a time series. Moreover, the specific examples in FIGS. 8 to 12 are merely examples and are not particularly limiting.

Also, in the exemplary embodiment described above, an operation of pressing a button for changing the screen is given as a non-limiting example of an operation on an element included on the terminal-side operation screen. The operation may be any operation for changing the display of content on the screen, and thus may also be a swipe operation or the like for scrolling the screen, for example.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising at least one processor configured to:
cause a terminal of a user to display, if a captured image of an image processing apparatus captured by the terminal includes an operation screen of the image processing apparatus, the operation screen included in the captured image as a terminal-side operation screen; and
cause each of the terminal and the image processing apparatus to perform processing according to an operation on an element included on the terminal-side operation screen.
   (((2)))

The information processing system according to (((1))), wherein the at least one processor is configured to:
cause either processing for activating a camera to capture an image of an operation screen of the image processing apparatus or processing for activating a software keyboard for accepting text input to be performed as the processing by the terminal according to the operation on the element; and
cause processing for accepting the operation as an operation on an operation screen of the image processing apparatus to be performed as the processing by the image processing apparatus according to the operation on the element.
   (((3)))

The information processing system according to (((2))), wherein if the operation on the element is an operation of changing display content of a screen, the at least one processor is configured to cause processing for activating the camera to capture the image of an operation screen of the image processing apparatus after the display content of the screen is changed to be performed as the processing by the terminal according to the operation.

(((4)))

The information processing system according to (((3))), wherein if the terminal has activated the camera and the operation screen of the image processing apparatus is displayed as an object of image capture on the terminal, the at least one processor is configured to cause the terminal to capture an image of the operation screen.

(((5)))

The information processing system according to (((2))), wherein if the operation on the element is an operation of selecting an object to input text into, the at least one processor is configured to cause the processing for activating the software keyboard for accepting text input to be performed as the processing by the terminal according to the operation.

(((6)))

The information processing system according to (((5))), wherein if the terminal has activated the software keyboard, the at least one processor is configured to accept an operation of copying and pasting text data stored in the terminal.

(((7)))

The information processing system according to any one of (((1))) to (((6))), wherein the at least one processor is configured to determine whether each of one or more objects forming the terminal-side operation screen corresponds to the element and to determine a type of the element on a basis of a result of machine learning using information pertaining to designs and rules governing the operation screen of the image processing apparatus as training data.

(((8)))

The information processing system according to (((7))), wherein the training data further includes information associating information about an operation performed on the element with a captured image of an operation screen displayed on the image processing apparatus in response to the operation.

(((9)))

The information processing system according to any one of (((1))) to (((8))), wherein the at least one processor is configured to:
manage the terminal-side operation screen displayed on the terminal in response to an the operation performed on the element in association with information pertaining to the operation; and
cause the terminal to display, if the operation on the element is performed, the terminal-side operation screen associated with the information pertaining to the operation.
   (((10)))

The information processing system according to (((9))), wherein the at least one processor is configured to cause the terminal to display the terminal-side operation screen and cause the terminal to display a button for activating a camera to capture an image of an operation screen of the image processing apparatus.

(((11)))

A program causing a computer to achieve:
causing a terminal of a user to display, if a captured image of an image processing apparatus captured by the terminal includes an operation screen of the image processing apparatus, the operation screen included in the captured image as a terminal-side operation screen; and
causing each of the terminal and the image processing apparatus to perform processing according to an operation on an element included on the terminal-side operation screen.

What is claimed is:

1. An information processing system comprising:
at least one processor configured to:
cause a terminal of a user to display, if a captured image of an image processing apparatus captured by the terminal includes an operation screen of the image processing apparatus, the operation screen included in the captured image as a terminal-side operation screen; and
cause each of the terminal and the image processing apparatus to perform processing according to an operation on an element included on the terminal-side operation screen.

2. The information processing system according to claim 1, wherein the at least one processor is configured to:
cause either processing for activating a camera to capture an image of an operation screen of the image processing apparatus or processing for activating a software keyboard for accepting text input to be performed as the processing by the terminal according to the operation on the element; and
cause processing for accepting the operation as an operation on an operation screen of the image processing apparatus to be performed as the processing by the image processing apparatus according to the operation on the element.

3. The information processing system according to claim 2, wherein if the operation on the element is an operation of changing display content of a screen, the at least one processor is configured to cause processing for activating the camera to capture the image of an operation screen of the image processing apparatus after the display content of the screen is changed to be performed as the processing by the terminal according to the operation.

4. The information processing system according to claim 3, wherein if the terminal has activated the camera and the operation screen of the image processing apparatus is displayed as an object of image capture on the terminal, the at least one processor is configured to cause the terminal to capture an image of the operation screen.

5. The information processing system according to claim 2, wherein if the operation on the element is an operation of selecting an object to input text into, the at least one processor is configured to cause the processing for activating the software keyboard for accepting text input to be performed as the processing by the terminal according to the operation.

6. The information processing system according to claim 5, wherein if the terminal has activated the software keyboard, the at least one processor is configured to accept an operation of copying and pasting text data stored in the terminal.

7. The information processing system according to claim 1, wherein the at least one processor is configured to determine whether each of one or more objects forming the terminal-side operation screen corresponds to the element and to determine a type of the element on a basis of a result of machine learning using information pertaining to designs and rules governing the operation screen of the image processing apparatus as training data.

8. The information processing system according to claim 7, wherein the training data further includes information associating information about an operation performed on the element with a captured image of an operation screen displayed on the image processing apparatus in response to the operation.

9. The information processing system according to claim 1, wherein the at least one processor is configured to:
manage the terminal-side operation screen displayed on the terminal in response to the operation performed on the element in association with information pertaining to the operation; and
cause the terminal to display, if the operation on the element is performed, the terminal-side operation screen associated with the information pertaining to the operation.

10. The information processing system according to claim 9, wherein the at least one processor is configured to cause the terminal to display the terminal-side operation screen and cause the terminal to display a button for activating a camera to capture an image of an operation screen of the image processing apparatus.

11. An information processing method comprising:
causing a terminal of a user to display, if a captured image of an image processing apparatus captured by the terminal includes an operation screen of the image processing apparatus, the operation screen included in the captured image as a terminal-side operation screen; and
causing each of the terminal and the image processing apparatus to perform processing according to an operation on an element included on the terminal-side operation screen.

12. A non-transitory computer readable medium storing a program causing a computer to execute a process comprising:
causing a terminal of a user to display, if a captured image of an image processing apparatus captured by the terminal includes an operation screen of the image processing apparatus, the operation screen included in the captured image as a terminal-side operation screen; and
causing each of the terminal and the image processing apparatus to perform processing according to an operation on an element included on the terminal-side operation screen.
